(19) United States
(12) Patent Application Publication
(10) Pub. No.: US 2008/0003425 A1
(43) Pub. Date: Jan. 3, 2008

(54) Systems and Methods of the Formation of Solid State Metal Boride and Oxide Coatings

(76) Inventors: James T. Spencer, Fayetteville, NY (US); Randy S. Rarig, Syracuse, NY (US)

Correspondence Address: BOND, SCHOENECK & KING, PLLC, ONE LINCOLN CENTER, SYRACUSE, NY, 13202-1355, US

(21) Appl. No.: 11/427,533

(22) Filed: Jun. 29, 2006

(51) Int. Cl. B05D 1/02; B32B 5/16; B32B 9/00

(52) U.S. Cl. 428/328; 427/421.1; 428/704

(57) ABSTRACT

A system and method for the formation of novel small particles, thin films, and coatings of solid state metal boride material. The metal boride materials may be formed using aerosol methods and/or spray pyrolysis to form a generally uniform, thin film coating of boride compound spheres. Boride solutions or compounds are sprayed via a gas nebulizer in a reactor containing a substrate and heated to approximately 900° Celsius. The boride compounds form uniform, spherical particles of approximately one micrometer in diameter. The boride compounds are extremely strong, non-reactive, dense, and, when prepared as films or coating, adhere very well to substrates, such as metals.

### BACKGROUND OF THE INVENTION

1. Field of Invention

The present invention relates to metal boride coatings and, more specifically, to aerosol and spray pyrolysis methods for forming solid state metal boride coatings.

2. Description of Prior Art

Methods for the coating of substrates with metal containing films are of significant commercial interest. The commercial interest covers a broad range of technological levels, from a relatively low technology standpoint involving the protection of mechanical and structural components to thermal, chemical, wear and impact damage, to high technology applications involving critical electronic and structural materials. The reduction or even elimination of component degradation which may ultimately lead to system compromise and failure is an area of critical concern to many fields. The discovery of methods and materials that would cover this range of applications would, therefore, be of great interest.

As seen in FIG. 1, metal borides are known with solid state structures which range from essentially isolated boron atoms through boron-boron bonded chains, two-dimensional continuous networks and complex three-dimensional frameworks which extend throughout the entire solid. The very strong multicenter, covalent bonding within the boron octahedral polyhedra is believed to impart the observed exceptionally high stability, hardness and high melting points to the boride materials. While it is not possible to entirely account for the boride structures in simple localized bonding terms, it is generally believed that the metal center donates electrons to the boron units in the boron rich compounds. In the case of materials such as NdB₆, the closo-boron octahedra require 14 valence electrons (2n+2), of which 12 are provided by the boron atoms. If the neodymium then provides two electrons to the cage, one “free” valence electron should remain per metal center, making the material an excellent conductor. This analysis is consistent with Hall effect, solid state B NMR and conductivity measurements on these materials. Also supportive of this analysis is the fact that MB₆ materials which contain only divalent metal centers, such as the alkaline earth hexaborides (i.e., CaB₆), are insulators rather than conductors, since no “free” electrons remain on the metal centers for conduction. Thus, the bonding description of the complex metal borides, such as the trivalent hexaborides, may be thought to contain both delocalized covalent bonding (within the polyhedra) and ionic bonding modes (between the polyhedra and the metal). The best electronic description of these materials, however, comes from a more complex molecular orbital treatment.

The synthesis of solid state metal boride materials has employed a variety of preparative strategies. In general, three techniques have been most commonly employed: (1) direct pyrolysis of the elements in vacuo at over 2000° C., (2) carbothermal or aluminothermal reduction of metal and boron oxides or carbides at 2000° C., and (3) high temperature electrolysis of molten baths. None of these traditional methods for preparing metal borides, however, may be in any sense termed general. These methods, however, typically require very high temperatures (above 1500° C.), employ the use of low volatility precursors, such as metal oxides and boron or boron carbide, and produce ceramic materials. Because of the nature of the synthetic techniques and the refractory properties of the metal borides themselves, pure metal boride materials have been both exceptionally difficult to prepare and analyze. In addition, the preparation of metal borides has focused almost entirely on the formation of bulk ceramic materials, rather than on the formation of high purity thin film or nanoscale structured materials.

The chemical vapor deposition of thin films of metal borides has previously presented significant challenges. The CVD of transition metal boride films from single-source metallaborane CVD precursors has recently been reported. In this chemistry, complexes such as [B₂H₆Fe₂(CO)₆], [B₂H₆Fe₂(CO)₆]₂, [HFe₃(CO)₉BH₄], and [HFe₃(CO)₉BH₂] have been used for the formation of iron boride thin films. While not a CVD process, the synthesis of bulk gadolinium boride phases, such as GdB₄ and GdB₆, from a single molecular precursor, Gd₂(B₁₀H₁₀)₃, at 1000-1200° C. has also been reported. While the single source feature of this method may seem attractive, the deposition of these films, however, has typically lacked sufficient compositional and phase control. Additionally, the deposited materials were either amorphous or crystallized only after prolonged annealing. Most importantly, however, is the fact that essentially all metallaborane complexes are comparatively difficult and time consuming to prepare in pure form and in sufficient quantities for CVD applications.

Transition metal borohydride complexes, such as Ti(BH₄)(dme) and Zr(BH₄)₄, have also been used as precursors in the CVD preparation of several metal boride thin films. It appears that when the metal coordination sphere is completed solely by borohydride ligands, metal boride films result. The application of these precursors, however, is severely limited by both the extreme instability/reactivity of these precursors and the synthetic difficulties encountered in the preparation of the metal borohydride complexes. For example, lanthanaborohydride complexes are rare, with little very known about the desirable neodymium and praseodymium borohydride complexes. Most of the transition metal and lanthanide borohydride complexes which are known, are insoluble, intractable, reactive, nonvolatile solids, rendering them inappropriate for CVD methods. Thus, the metal borohydride precursors are of only very limited potential for the CVD metal boride formation but of significant interest in the aerosol-based methods.

Aerosol decomposition methods are also very useful techniques for producing multi-component, high-purity refractory materials that consist of non-agglomerated submicrometer or nano-sized particles. Typically, several precursors, each containing components of the final solid state material, are mixed in a suitable solvent that is then atomized into a heated reactor. As the aerosol passes through the heated reactor, the solvent evaporates to create a concentrated solution of precursors which interact and react to form of the final particle. Spray pyrolysis has been used to generate a wide variety of important materials in powder form. Aerosol methods have produced silver, palladium, copper, gold, molybdenum, nickel, and tungsten fine metal particles, among others. Nonoxide ceramic powders, mainly Si₃N₄ from polysilazane precursors and boron nitrides from poly(borazinylamine) precursors or from aqueous boric acid and ammonia gas, have also been reported. Fine powders of superconducting materials such as YBa₂Cu₃O₇₋ₓ, Bi—Sr—Ca—Cu—O, La—Sr—Cu—O, Tl—Ca—Ba—Cu—O, and YBa₂Cu₄O₈ in the 10 nm to 80 nm range have been produced using spray pyrolysis with aqueous metal nitrate solutions of the desired starting materials. Fullerene nanocomposites and other nanophase materials have also been reported through the use of spray pyrolysis. This technique, however, has not been used for the formation of metal boride solid state materials.

### SUMMARY OF THE INVENTION

It is a principal object and advantage of the present invention to provide a method for forming metal boride solid state materials that may be used in a variety of application.

It is an additional object and advantage of the present invention to provide a method for forming metal boride solid state materials that is relatively easy to implement.

It is a further object and advantage of the present invention to provide a method for forming metal boride solid state materials that does not require prolonged annealing

Other objects and advantages of the present invention will in part be obvious, and in part appear hereinafter.

In accordance with the foregoing objects and advantages, the present invention comprises aerosol and spray pyrolysis methods for forming metal boride oxide coatings. One embodiment of the method of the present invention involves the technique of spray pyrolysis (flame or plasma) using pre-formed metal boride materials, either pure or mixed with other components, often as fluxes. Very finely powdered solid is sprayed directly either through a flame or plasma to instantaneously melt boride into very fine molten particles that are then directed to the surface of a substrate. The second embodiment of the method of the present invention employ an aerosol of precursors that can be sprayed into the hot zone to first evaporate the solvent carrier and then deposit solid state material, such as metal boride. A solution of the boron source is used to form a fine aerosol which is injected into the hot zone of a reactor concurrently with gas phase titanium source.

### BRIEF DESCRIPTION OF THE DRAWINGS

The present invention will be more fully understood and appreciated by reading the following Detailed Description in conjunction with the accompanying drawings, in which:

FIG. 1 is a schematic of the typical structure of metal boride materials.

FIG. 2 is a high level schematic of the method of the present invention.

FIG. 3 is a chart of the results of an auger depth experiment on compounds formed according to the present invention.

FIG. 4 is a series of micrographs of films produced according to the present invention.

FIG. 5 is a series of micrographs of metal oxide coatings produced according to the present invention.

FIG. 6 is a series of micrographs of metal boride coatings produced according to the present invention.

FIG. 7 is a schematic of a system according to the present invention.

FIG. 8 is a schematic of a practical application of a boride file coating prepared according to the present invention.

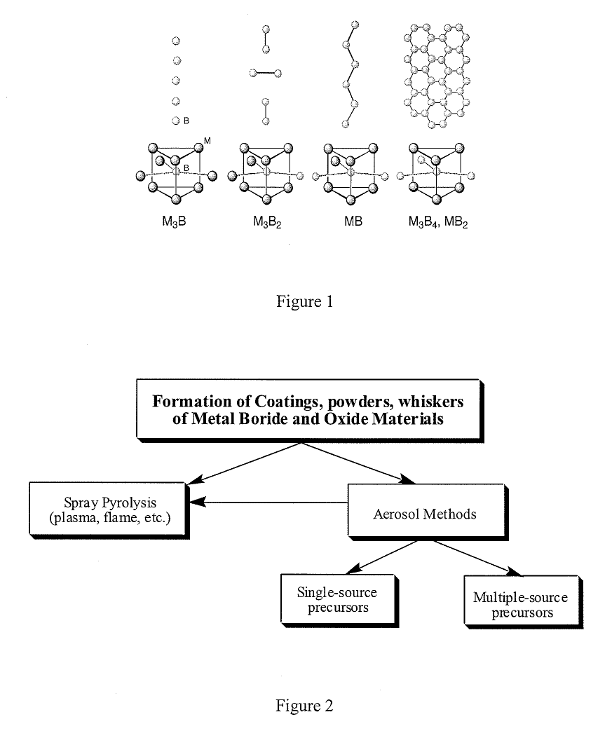

### DETAILED DESCRIPTION

Referring now to the drawings, wherein like numerals refer to like parts throughout, there is seen in FIG. 2, a high level schematic of the methods of the present invention for forming metal boride and oxide materials via spray pyrolosis and aerosol techniques.

One embodiment of the present invention involves the technique of spray pyrolysis (flame or plasma) using pre-formed metal boride materials, either pure or mixed with other components, often as fluxes. Very finely powdered solid is then sprayed directly either through a flame or plasma to instantaneously melt boride into very fine molten particles that are then directed to the surface of a substrate. The primary difference between the flame and plasma methods is that the flame method works well for metal boride precursors whose melting points are below 2000° C., while this is not a problem for plasma methods (since the plasma generates temperatures near 10,000° C.).

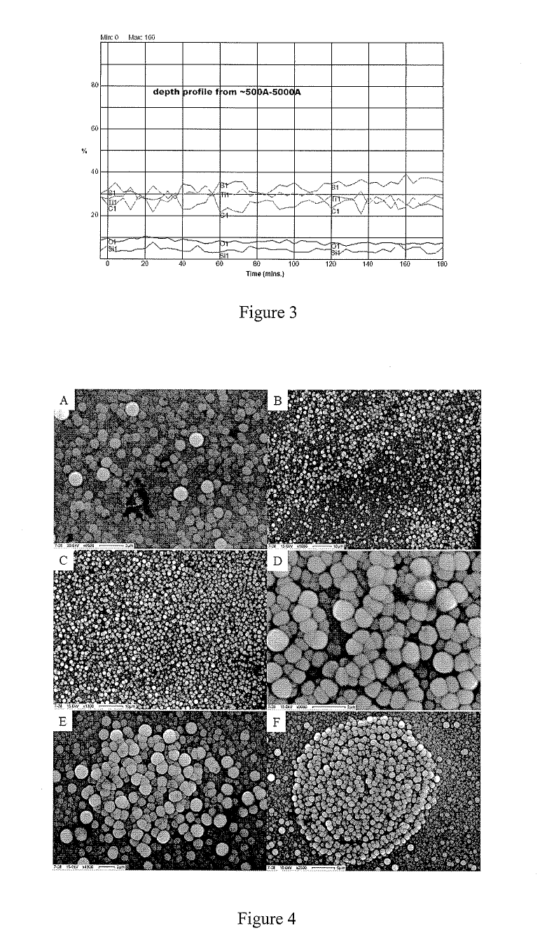

A second embodiment of the present invention employs an aerosol of precursors that can be sprayed into the hot zone to first evaporate the solvent carrier and then deposit solid state material, e.g., metal boride. In this technique, a solution of the boron source is used to form a fine aerosol which is injected into the hot zone of a reactor concurrently with gas phase titanium source. In an experiment according to this embodiment of the present invention, the solid material found in the reactor was analyzed by Auger electron spectroscopy (AES), the results of which are reproduced in FIG. 3, which shows the auger depth profile experiment from an estimated 500 Å to 5000 Å depths of the aerosol-deposited film formed from the reaction of TiCl₄ and decaborane(14) in acetonitrile at 900° C. on quartz. The AES plot shows that the bulk composition of the sample was very uniform and composed of nearly equal parts boron, carbon, and titanium, with little to no silicon, oxygen or chlorine present. The bulk compositions of such samples also show little variation in the concentration of any of the components.

An analysis of the aerosol formed material was performed utilizing X-ray diffraction experiments to determine phase information on these materials. Referring to FIG. 4, aerosol deposited film formed from TiC14 and decaborane(14) in acetonitrile at 900° C. and atmospheric pressure, on quartz is shown at magnifications ranging from 1000× to 9000× (scale bars shown). Scanning electron microscopy (SEM) shows that the formed solid state material contains uniform, well-formed spherical products. The spheres formed have very clear boundaries with an average size of 1.02 μm and a standard deviation of 0.16 μm. Smaller particles are also possible by modification of the aerosol generation process. This embodiment of the present invention thus makes very spherical particles and generates a relatively small size distribution of spheres.

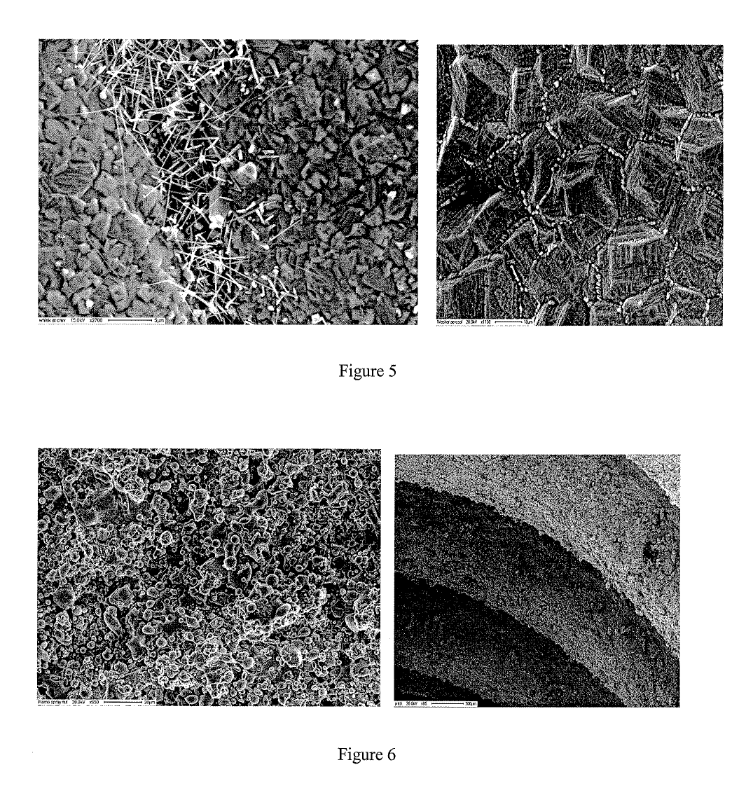

Another embodiment of the present invention involves an aerosol-based technique for forming dense, conformal thin films and metal-containing coatings on a variety of substrates, including steel. In this technique, a pre-formed TiB₂ solid is dissolved in a 3% aqueous hydrogen peroxide solution. Initially, a very stable gel is formed that can then be diluted further to form a free-flowing solution. The TiB₂/H₂O₂(aq) solution is then used in the aerosol pyrolysis equipment to generate very dense, conformal (void-free) coatings, as seen in FIG. 5, which shows a metal oxide coating generated from TiB2/H2O2(aq) using aerosol methods at 900° C. The coatings cover all exposed surfaces, including those with irregular surfaces. The coatings generated according to this embodiment are corrosion resistant and adhere exceptionally well to the substrates. These coatings have been shown by XRD to be primarily dense, conformal hematite-like spinel phases with traces of titanium and boron in the coating.

The titanium boride materials may be prepared either with decaborane(14) and TiCl₄ as the source compounds (aerosol without peroxide) or directly from TiB₂ (peroxide methods). In the first method, the decaborane(14) was replaced, especially for the formation of more complex ternary and quaternary materials. Other boron sources may work well including both cluster (such as [B₁₀H₁₀]⁻² and [B₁₂H₁₂]⁻²) and non-cluster based species (such as B₂H₆, BH₂R, B₂Cl₄, and BH₃L). Additionally, single source precursors, in particular the tetrahydroborates of titanium, zirconium, hafnium and many other tetrahydroborate metal compounds, may be synthesized utilizing the transition metals, lanthanide metals, and the actinide metals. While not particularly useful as CVD sources, these compounds may be fruitful precursors in aerosol applications. Since many tetrahydroborate metal compounds are known to thermolyze under mild conditions to give hydrogen and various amounts of diborane, they should act as excellent precursors for aerosol-formed metal boride materials. Unlike metal halides, tetrahydroborate metal compounds have very good solubility in a variety of organic solvents, making them ideal for aerosol decomposition precursors.

Spray pyrolytic methods (flame and plasma) according to the present invention begin with the pre-formed metal boride materials, either pure compounds or mixed with other components such as other borides and/or a variety of metallic fluxes (e.g., Zn, Al, Ni, Co). The very finely powdered solid is then either sprayed directly through a flame or through a plasma to instantaneously melt the boride into very fine molten particles that then are directed to the surface of a substrate. Typical flame pyrolytic boride-containing coatings are reproduced in FIG. 6, which (from left to right) depicts an SEM micrograph of NiB in flux coating and an SEM micrograph of NiB in flux coating on inner screw threads. The primary difference between the flame and plasma methods is that the flame method works well only for metal boride precursors whose melting points are below 2000° C. while plasma methods work for all of the borides (since the plasma generates temperatures near 10,000° C.). In addition, it is well known that spray plasma pyrolytic methods form exceptionally dense, void-free coatings even on thermally sensitive substrates such as plastics. Using pyrolytic methods for forming boride-containing coatings on substrates offers an economically and experimentally viable pathway to provide coatings with the unparalleled chemical and physical properties of the boride materials.

Scanning electron micrographs (SEM) of experimental tests of the present invention were obtained on an ETEC autoscan instrument in the N.C. Brown Center for Ultrastructure Studies of the S.U.N.Y. College of Environmental Science and Forestry, Syracuse, N.Y. Photographs were recorded on Kodak Ektapan 4162 film or digitally. X-ray Emission Spectra (XES) were obtained on a Kevex 7500 Microanalyst System. The X-ray diffraction patterns (XRD) were recorded on a Brucker D8 Advance powder diffractometer. Copper K_{α} radiation and a graphite single crystal monochromator were employed in the measurements reported here. FT-IR spectra in the range of 400 to 4000 cm⁻¹ were measured on a Mattson Galaxy 2020 spectrometer and were referenced to the 1601.8 cm⁻¹ band of polystyrene. All materials were recorded as suspensions in Nujol mulls sandwiched between NaCl plates.

The non-aqueous solvents used in tests of the present invention were of reagent grade or better and were dried prior to use. The nido-decaborane(14), B₁₀H₁₄, was purchased from the Callery Chemical Company and was purified by vacuum sublimation at 40° C. prior to use. The anhydrous (99.9%) metal boride starting materials (such and TiB₂, FeB, Ni₃B, etc.) were purchased from Cerac Chemical Company and were used as received.

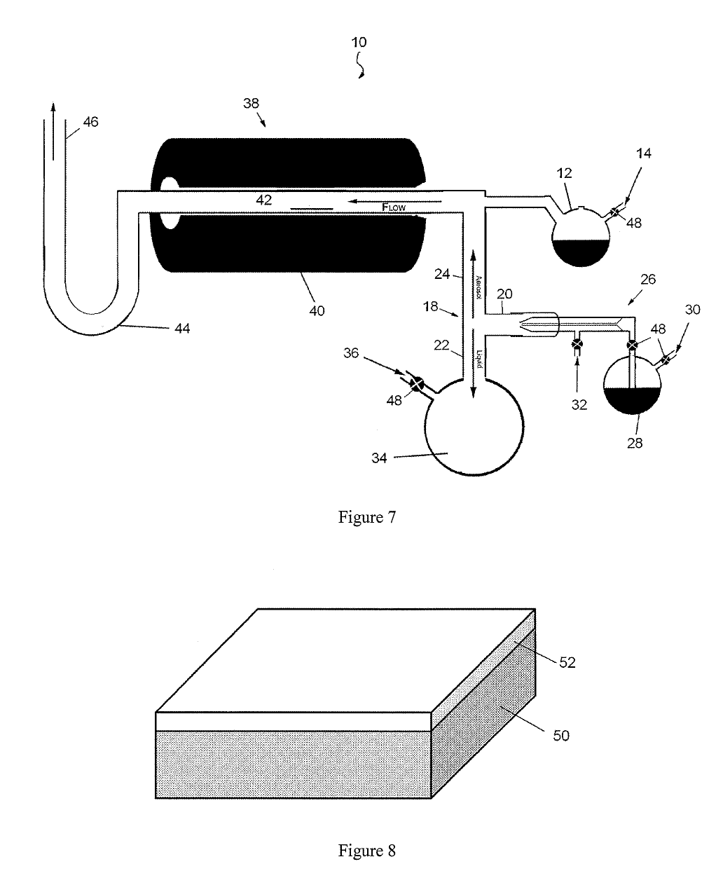

A schematic diagram of a system 10 according to the present invention is shown in FIG. 7. System 10 includes a titanium chloride source flask 12, such as a Schlenk flask, in an inert atmosphere. Source flask 12 includes a carrier gas inlet 14 and a source flask outlet 16. Outlet 16 communicates with an aerosol/liquid separation chamber 18 having a nebulizer input 20, a liquid outlet 22 and an aerosol outlet 24. A nebulizer 26 comprising a solution flask 28, a nebulizer gas inlet 30, and a carrier gas inlet 32, all of which communicate with nebulizer input 20. Liquid outlet 22 communicates with a collection flask 34 having a carrier gas inlet 36. Aerosol outlet 24 communicates with source flask outlet 16 and is directed into a deposition reactor 38. Deposition apparatus 38 comprises a tube furnace 40 that surrounds a substrate 42. Reactor 38 communicates with a collection tube 44 and an exhaust 46. Multiple valves 48 are positioned throughout system 10 to provide selectivity of gas insertion.

With regard to the aerosol embodiments of the present invention, powdered titanium boride (TiB₂) was added slowly to stirring 3% hydrogen peroxide to create a 0.05M solution. After stirring for a few minutes the solution turned slightly viscous and yellow in color. The solution was then transferred to a Schlenk tube and attached to an aerosol apparatus. A small piece of mild steel was placed in the hot zone of the aerosol reactor and the temperature was ramped to between about 600 and 900° C. A flow of argon gas was used as a carrier for the TiB₂/H₂O₂ solution. The solution was passed through the hot zone and over the steel. Residual solution was collected in a trap at the end of the aerosol chamber. A thin, dense and highly adhered film of TiB₂ was deposited on the chunk of steel in the hot zone. The coating was found to contain, in varying amounts, iron, oxygen, titanium and boron.

### EXAMPLE

With regard to the aerosol deposition involving titanium (IV) chloride and Decaborane(14), a 0.01 M solution of decaborane (0.1 M borane) was prepared in dry, degassed acetonitrile in a Schlenk flask under an inert atmosphere. One opening of the Schlenk flask was attached to the liquid entry tube of the nebulizer and the other was attached to a nitrogen gas inlet for pressure equalization. The nebulizer was aligned to spray into an aerosol/liquid separation chamber. In a 3-necked, 250 mL flask under an inert atmosphere, 10 mL of titanium(IV) chloride were added. The flask was then connected in line with the carrier gas and a hot wall deposition apparatus. The tube furnace of a hot wall deposition apparatus was equipped with an external chromel-alumel thermocouple for accurate temperature control. The cooling/collecting tube was immersed in a liquid nitrogen bath to cool the heated compounds before being vented into the hood. The tube furnace was first heated to between 900°-950° C. under a flow of dry nitrogen (thermocouple outside tube). Once the reaction temperature was constant for 15 minutes, the valve of the flask containing the metal precursor was opened allowing the carrier nitrogen flow through the hot wall apparatus. The valve to the boron precursor solution was opened and the solution flowed into the capillary of the nebulizer generating the aerosol. Once the precursors were consumed, the tube furnace was shut down and the hot wall reactor was cooled to room temperature. The resulting liquid that had collected in the cooling/collection tube was filtered and any residue was collected for further analysis (SEM, EDAX). The interior of the hot wall reactor was then examined visually and any built-up deposits were scrapped off of the walls for analysis (SEM, EDAX). The quartz substrates were removed from the deposition apparatus and the deposited film was analyzed (SEM, EDAX, Auger).

With regard to the deposition of metal borides by spray methods, metallic borides with melting points below 2000° C. were individually mixed with other materials (including other borides and/or Al, Zn, Co, Ni, etc.) in order to make a self-fluxing metallic powder. The powder was then placed into the powder hopper of a thermal spray-welding gun. The surfaces of mild steel were cleaned, in some cases, with hot 0.1M HCl solution and then coated, in some cases, with iron phosphate to give a flat black appearance. The steel was then coated with the self-fluxing metallic boride powder using the thermal spray method. The coatings were then annealed in the flame for several minutes to insure a dense and adhered coating. The coatings exhibit dense crystallite packing on the surface of the steel and good adhesion to the steel substrate. The coatings also exhibit very good corrosion resistance and machinability. The materials were found by X-ray diffraction to be metal boride materials (with only trace amounts of the corresponding oxides).

The metal borides of the present invention possess an extraordinary range of chemical and physical properties, significantly greater than for any other single class of solid state materials. These properties make them excellent candidate materials for a large array of applications including as refractory (including corrosion resistant) materials, optoelectronic and thermionic materials.

The metal borides of the present invention are typically very refractory materials, possessing very high melting points, exceptional hardnesses, and high thermal electric conductivities. Selected data for several metal boride materials with comparative data for several other relevant materials are given in Table 1 below. For example, the diborides of Zr, Hf, Nd, and Ta all have melting points well in excess of 3000° C., far exceeding the respective melting points of the pure parent metals. An important characteristic property of many metal borides is that they possess electrical conductivities of a metallic order and several borides, such as LaB₆ and TiB₂, have electrical resistances very much lower than the corresponding pure metals (i.e., over five times lower for TiB₂). Analysis of single crystalline metal borides shows that the ultimate resistivities of these materials approaches those of the very best metallic conductors (i.e., 1.1 and 2.9 μohm-cm for TiB₂ and ZrB₂, respectively). Materials which contain even small amounts of boron do not display electromigration effects, even under very large current densities. Metal boride materials, such as HfB₂, are currently used in applications such as electrodes and photothermal absorbers which capitalizes on these physical and electronic properties.

The metal borides of the present invention also exhibit enormous thermal and oxidative stability and are not attacked by dilute acids, bases or even concentrated mineral acids. Because of these properties, metal borides have found critical uses in applications ranging from “low technology” hard cutting surface coatings to advanced optoelectronic systems. These materials are may be used in patterned depositions on semiconductor substrates for use in high electron mobility transistors (HEMT), pseudomorphic and heterostructural devices, heterojunction bipolar transistors (HBT), and ultra-high speed microelectronic devices.

TABLE 1
Properties of Refractory Materials

| | | | | | | | |
|---|---|---|---|---|---|---|---|
| | | Spec. Elec. | | Max. | Resistance to | Micro- | Thermal |
| | Resist. | Cond. | Density | Resistance | Oxidation | hardness | Exp. Coef. |
| Matl. | {μΩcm}^{c} | {Ωcm} | {gmcm⁻³} | Temp (° C.) | {Δwtcm⁻²hr⁻¹} | {Kgmm²} | (10⁶) deg⁻¹ |

MAIN GROUP MATERIALS

| | | | | | | | |
|---|---|---|---|---|---|---|---|
| C_{(dia)} | 10²⁰ | 10⁸ | 3.51 | >3550 | stable to > | ⋄ | 4.4 × 10⁻⁶ |
| | | | | | 800° | | |
| BN | 1.7 × 10¹⁹ | 5.9 × 10⁻¹⁴ | α = 2.29, β= | α = 3000 | +0.167 mg @ | ⋄ | 0.5 − 1.7 |
| | | | 3.45, γ = | β = 1650 | 1000° | | |
| | | | 1.80 | | | | |
| B₄C | 1 × 10⁶ | 1 | 2.517 | 2450 | −0.113 mg @ | 4000 | 4.5 |
| | | | | | 1200° | | |
| SiC | >0.13 × 10⁶ | <7.7 | 3.208 | 2540 | +0.0173 mg | 3500 | 4.7 |
| | | | | | @ 1400° C. | | |

METAL BORIDE MATERIALS

| | | | | | | | |
|---|---|---|---|---|---|---|---|
| HfB^{b} | 45.8 | 21,800 | 12.405 | 3250 | — | 2900 | 6.5 |
| ZrB^{b} | 32.2 | 31,100 | 6.48 | 3200 | +0.2 mg @ | 3600 | 5.9 |
| | | | | | 695° | | |
| TaB^{b} | 100 | 10,000 | 15.240 | 3090 | +1.9 mg @ | 3130 | 8.2 |
| | | | | | 700° | | |
| WB^{b} | 85 | 11,760 | 15.734 | 2740 | not oxidized | 3700 | 6.7 |
| | | | | | @ 800° | | |
| GdB^{b} | 31.1 | 32,200 | 6.03 | >2500 | — | 1900 | 7 |
| NiB^{b} | 14 | 47,600 | 7.195 | 2320 | — | 1430 | — |
| FeB^{b} | 80 | 12,500 | 7.336 | 1980 | — | 1650 | ~8 |

^{a}Data taken from refs. 1 and 2 and refs. therein.
^{b}Does not imply stoichiometry of the phase.
^{c}Resistivity measurements may have been determined from materials with some residual porosity thus giving artificially high values.
†Hardness of 9 on the Mohr Scale (0–10 range).
⋄Hardness of 10 on the Mohr Scale (0–10 range).

The lanthanide metal borides of the present invention are of significant interest due not only to their refractory, magnetic and electrical properties but also because of their potential use as excellent thermionic materials. Lanthanum hexaboride, for example, has the highest electronic emissivity of any known material and its performance is unaffected by the presence of either nitrogen or oxygen (i.e., work functions of 2.74 and 2.22 eV for LaB₆ and YB₆, respectively). Devices that utilize this property have been proposed to employ La(Ce)B₆ in very low temperature single-photon energy resolving detectors. Lanthanum hexaboride thin film cathodes have also recently been successfully used to replace nickel cathodes in display panels. These rare earth boride cathodes have been shown to work very efficiently at significantly lower voltages than the corresponding nickel cathodes.

The metal borides of the present invention are also excellent magnetic materials. Gadolinium boride, for example, is one of the strongest magnets among the binary materials while nanostructured neodymium iron boride is anticipated to have exceptionally high magnetic properties, well beyond those observed for all other permanent magnetic materials. Numerous other boride materials (e.g., CoSmB) have also been employed as magnetic media for a variety of critical applications.

The metal boride materials of the present invention, due to their very high thermal and high energy neutron capture cross sections (higher than for any other nuclide), have may be used as neutron shields and in related “nuclear-hardened” electronic and structural applications.

Materials produced according the present invention may also have applications as tribological (wear resistant) materials. The protection of mechanical and structural components from chemical, impact and wear damage, in efforts to greatly reduce or even eliminate component degradation which may ultimately lead to system compromise and failure, is an area of critical concern to many fields, especially aerospace, transportation and other high performance uses. This concern often stems from both economic and “safety”-related issues. The lifetime of the protection afforded by a chemical and tribological coating directly relates to the ultimate economic benefit provided by the coating. The commercial implications are very clear considering that many billions of dollars are spent annually to replace components damaged through either ineffective or non-existent protective coatings. Potentially more important, however, are “safety” issues which relate to the possible catastrophic system failure of critical structural and mechanical elements in aerospace and defense systems. Space and aerospace-based platforms, in particular, are often subjected to extremely harsh chemical and wear environments that may compromise sensitive components without adequate protection. It is also clear that the lifetimes and ultimate viability of many non-aerospace systems are often severely limited by oxidation and wear damage.

For many applications, protective materials must be extremely hard, strong, chemically inert, lightweight, gall and fret resistive, and cost effective to produce. The metal borides of the present invention are one class of materials, however, that meets essentially all of these requirements. The present invention allows for the fabrication of exceptionally hard films of metal boride coatings at relatively low temperatures and thus overcomes many of these difficulties. The metal boride materials of the present invention will not only provide coatings that are believed to meet all the protection requirements described above, but also provide a unique array of other chemical and physical properties that allow them to be important integral components in complex mechanical, structural and electronic systems.

Materials produced according to the present invention may also be used to replace chromium and cadmium coating. A particularly attractive application for main group and metal borides is as cadmium and chrome plating replacements. Cadmium and chrome hard platings are used extensively in a variety of applications including on aircraft parts like pistons, joints, actuators, and other landing gear components. Environmental and health regulations enforced by the EPA and OSHA are in large measure driving industry to replace the extensive cadmium and chrome platings currently employed since there metals have very high toxicities and are very costly to treat and dispose. These factors have made cadmium and chrome coatings targets for reduced usage or elimination.

Metal boride coatings should be excellent alternatives to hard cadmium and chrome plating on aircraft landing parts due to their exceptional hardness, wear-resistance, and corrosion resistance. As seen in the table below, the desired characteristics in the industry are well within the performance parameters of the metal borides of the present invention. In the areas of hardness, thickness, heat resistance, wear resistance, and corrosion resistance, metal borides are exceptionally well-suited to address these end-user requirements.

Materials produced according to the present invention may serve as refractory fibers and composites. The formation of enhanced structural materials and composites through stronger and more lightweight fiber components is also an area of critical concern. Both space and land-based defense and aerospace systems must withstand significant thermal, wear and structural stresses in order to be viable. These difficult demands, coupled with the additional need to provide inexpensive and lightweight materials, makes the development of suitable new fiber composites a great challenge. As with the protective coatings described above, the boride-based materials of the present invention should provide a unique solution to many of these materials challenges.

Two approaches are viable for new enhanced structural fibers: coating currently available fibers with boride materials to enormously enhance their thermal, structural and wear properties, and fabricating the fibers themselves from boride-based materials. The first technique, fiber coating, provides enormous versatility since a wide variety of fiber materials are currently available with far ranging structural and physical properties. The coating technique may be done inexpensively and at relatively low temperatures using our methods should provide new fibers of enhanced stability, wear resistance, and strength. The second technique, using borides as the fibers themselves, provides the opportunity to completely design new fibers with specifically tailored properties, including mixed binary phases (i.e., ZrB₂ for flexibility coupled with TiB₂ for extreme strength). Titanium diboride, at elevated temperatures, has the greatest tensile strength-to-weight ratio known for any material with a dilational strain resistance almost that of diamond. Mixed binary phases, such as TiB₂/ZrB₂, also have hardnesses significantly greater that SiC. These approaches of the present invention to new fiber fabrication will lead significant advances in the strength and durability of composite materials.

The present invention may also be used to formulate improved brake pad and disk coatings. Recently, it has become clear that conventional and carbon composite aircraft braking materials are problematic and expensive to produce. There are numerous difficulties associated with state-of-the-art carbon composite materials, including: a relatively low friction coefficient, fluctuations in the friction coefficient with respect to temperature, degradation by solvents commonly used on and around aircraft, and a low resistance to oxidation. One alternative to carbon composite brake materials are boride materials, which address many of the problems associated with the current materials. The properties of boride films of the present invention, such as extreme hardness, high melting point, low thermal expansion, high elasticity and high resistance to oxidation, offer a greatly improved alternative to the current conventional and carbon composite braking material. Referring to FIG. 8, one possible design for a braking component would be to form a ceramic base 50 (either a traditional ceramic or a main group boride ceramic) which could then be coated with a boride material 51, such as a metal boride (TiB₂, ZrB₂, etc.), boron carbide, or silicon doped boron carbide film. This design couples the low weight structural stability of borides with their extreme hardness and wear features.

Materials formed according to the present invention may also have usefulness in the field of microelectronics. As previously described, most metal borides are excellent electrical conductors with ultimate resistivities that approach those of the very best metallic conductors. In addition, materials that incorporate even small amounts of boron do not display electromigration effects, even under very large current densities. These properties, coupled with their intrinsic strength and high thermal and oxidative stability, make metal borides exceptional candidates for microelectronic applications. The methods of the present invention for the fabrication of both conformal and patterned thin films of metal borides should be of direct significance to the microelectronics industry.

Materials formed according to the present invention may also be used in connection with magnetic materials. Permanent magnets are ubiquitous technological materials with a growing annual market estimated at $3 billion. Until 1983, this market was dominated by alnico and SmCo-based materials. The availability and cost of cobalt and samarium-based magnets are particularly problematic due to the supplies of these elements and the relatively large component of these elements in the magnets. Referring to FIG. 2, boride-based magnets, such as Nd₂Fe₁₄B and GdB, have much higher magnetic energy products (>400 kJm⁻³) than previously known materials. The boride-based magnets also have some significant advantages due to their physical and chemical properties. Metal boride magnetic materials may be developed through a refinement of existing materials deposition and fabrication techniques to fit particular applications, such as consideration of the effect of deposition method, temperature, annealing, sample history, and interfacial boundaries, and rapid materials discovery to find new, enhanced magnetic boride materials, such as through the formation of new ternary, quartenary, and mixed phase borides coupled with their fabrication in nanostructured materials.

The exploration of borides according to the present invention as magnetic materials can be accomplished readily through the use of combinatorial techniques. Combinatorial methods have been used extensively to very great advantage in the development of new pharmaceutical and biological materials. Recently, however, these techniques have been equally well employed in solid state materials development. In combinatorial chemistry, large numbers of related compounds and materials in spatially addressable arrays are statistically generated and then quickly screened to maximize a desired response. This technique provides for the preparation and evaluation of thousands of new materials (called “libraries”) in the time it formerly took to prepare and evaluate a single new material. In addition, duplicate libraries of new materials can be prepared and then subjected to different processing techniques and environments to rapidly explore the effect of processing upon the desired property. It is important to note that the libraries prepared in this work can also be very easily screened for other properties such as conductivity, corrosion resistance, and strength without the fabrication of new samples.

Combinatorial methods are only valid, however, when the techniques used to prepare and evaluate the libraries are the same as those ultimately used to fabricate the final material. This is due, in large part, to the often direct dependence of the materials properties on grain boundaries, particle size, homogeneity, and interfacial properties which are sensitive to the fabrication method. In the combinatorial methods of the present invention, however, the deposition techniques used to form the libraries are the same techniques as those to be employed in the large scale materials fabrication.

Very strong, permanent magnetic materials have great potential to many technological applications. The few listed below are those for which materials formed according to the method and techniques of the present invention can make a considerable impact with the shortest development time.

Materials formed according to the present invention may also be used for magnetic resonance imaging (MRI) technology. MRI is currently widely employed for the non-invasive, non-destructive imaging of biological structure and function. Current MRI imagers typically employ high field superconducting magnets operating near liquid helium temperature (4 K). The largest cost component involved in the fabrication and maintenance of these imagers is the superconducting magnet and its cooling systems. Permanent high field magnets provide considerable savings in both the fabrication and maintenance of imagers. Thin film, nanophase metal boride-based magnetic materials according to the present invention should provide an attractive cost-effective alternative to the superconducting magnets.

Materials formed according to the present invention may also be used in high efficiency motors and actuators. The largest current use of permanent magnetic materials are in motors and actuators. Higher strength, durability and magnetic fields (including Tc and coercivity) should dramatically impact these markets. Similarly, materials formed according to the present invention may be used for frictionless bearings and Maglev transportation to reduce friction through repulsive magnetic fields using thin films of boride-based materials according to the present invention.

A variety of well known applications of magnetic materials may be improved by materials formed according to the present invention. Magnetoresistive devices have recently gained considerable interest because of the potential application of these materials in magnetic storage devices. The magnetoresistive effect involves the changing of the electrical resistance of a material, including, magnetic materials, as an external magnetic field is applied. The magnetocaloric effect involves either the inductive heating or cooling of a metal upon placing it in an external magnetic field. Recently, a prototype very high efficiency refrigerator has been reported using high field permanent magnets and magnetocaloric metals. This device would benefit from boride materials according to the present invention.

What is claimed is:

1. A method of forming a metal boride oxide coating, comprising the steps of:
(a) positioning a substrate in a reactor; and
(b) spraying a boride compound into said reactor with a nebulizer.

2. The method of claim 1, wherein the boride compound is decaborane.

3. The method of claim 1, further comprising the step of:
(c) simultaneously spraying a titanium (IV) chloride solution into said reactor.

4. The method of claim 3, further comprising the step of:
(d) heating the reactor to between about 900 and 950 degrees Celsius under a flow of dry nitrogen.

5. The method of claim 4, wherein the reactor comprises a tube furnace.

6. The method of claim 5, wherein the substrate is steel.

7. The method of claim 6, wherein the steel is coated with spheres having an average size of about 1 micrometer.

8. A method of forming a metal boride oxide coating, comprising the steps of:
(a) preparing a solution of a metal boride; and
(b) positioning a substrate into a reactor; and
(c) spraying the solution into the reactor using a carrier gas.

9. The method of claim 8, wherein the metal boride solution is a solution of titanium (IV) boride and hydrogen peroxide.

10. The method of claim 9, further comprising the step of:
(d) heating the reactor to between about 600 and 900 degrees Celsius.

11. The method of claim 10, wherein argon is the carrier gas.

12. The method of claim 11, wherein the substrate is steel.

13. The method of claim 12, further comprising the step of:
(e) passing the solution through the reactor and over the substrate.

14. The method of claim 13, wherein the reactor is a tube furnace.

15. The method of claim 14, wherein the steel is coated with spheres having an average size of about 1 micrometer.

16. A metal boride coated compound, comprising:
a substrate; and
a plurality of spheres including about equal parts boron, carbon, and a metal compound positioned on the substrate.

17. The compound of claim 16, wherein each of the plurality of spheres is about 1 micrometer or less in diameter.

18. The compound of claim 17, wherein the spheres are about 1 micrometer in diameter.

19. The compound of claim 18, wherein the metal compound is at least one metal selected from the group consisting of titanium, aluminum, zinc, cobalt, nickel, zirconium, hafnium, neodymium, gadolinium, samarium and tantalum.

20. The compound of claim 18, wherein the metal compound is titanium.
